(19) United States
(12) Patent Application Publication
(10) Pub. No.: US 2008/0074505 A1
(43) Pub. Date: Mar. 27, 2008

(54) Phosphors for enhancing sensor responsivity in short wavelength regions of the visible spectrum

(75) Inventors: Magnus Ryde, Atherton, CA (US); Wei Shan, Fremont, CA (US); Xiao-Dong Xiang, Danville, CA (US)

Correspondence Address: BUCHANAN, INGERSOLL & ROONEY PC, POST OFFICE BOX 1404, ALEXANDRIA, VA, 22313-1404, US

(73) Assignee: Intematix Corporation, Fremont, CA (US)

(21) Appl. No.: 11/881,247

(22) Filed: Jul. 25, 2007

Related U.S. Application Data
(60) Provisional application No. 60/833,761, filed on Jul. 26, 2006.

(51) Int. Cl. H04N 5/225

(52) U.S. Cl. 348/218.1; 348/207.99; 348/E05.024

(57) ABSTRACT

Disclosed are apparatus and methods of improving of the spectral responsivity of color image sensors that are inherently inefficient in the short wavelength range of the visible spectrum. By using a phosphor composition as a spectral shifter to absorb the short wavelength portion of the incident light, the phosphor then re-emitting the light at longer wavelengths, the maximum of spectral response (the peak of quantum efficiency) of the sensor may be better matched.

### CROSS REFERENCE TO RELATED APPLICATION

This application claims the benefit of priority to U.S. Provisional Patent Application No. 60/833,761, filed Jul. 26, 2006, the specification and drawings of which are incorporated herein by reference.

### BACKGROUND OF THE INVENTION

1. Field of the Invention

Embodiments of the present invention are directed in general to color imaging technologies that render the brightness recorded by each pixel of an imaging sensor into a color image. The field of the invention is specifically directed to a phosphor-based spectral shifting mechanism that may be incorporated into the color imaging system to enhance its spectral responsivity in short wavelengths of visible spectrum.

2. Description of the Related Art

Since daylight is made up of red, green, and blue light, color image sensors are designed to detect three overlapping segments of the visible spectral continuum by the action of red, green and blue optical bandpass filters. An image sensor comprises individual photosites. By placing these red, green, and blue filters over the individual photosites of an image sensor, one may create color images.

In the popular Bayer pattern used by many image sensors, there are twice as many green filters as there are red or blue filters. This concept is illustrated generally at reference numeral 10 in FIG. 1, where a first row 11 of the pattern alternates between red and green filters, and the second row 12 alternates between green and blue filters. The need for having twice as many green filters as either red or blue filters is dictated by the fact that the human eye is more sensitive to green than to the other two colors. Thus, the accuracy of the green color in an image is more important. Because a colored filter (in the filter layer 13 in FIG. 1) covers each photosite 14A, 14B, 14C, etc. of the image sensor 14, only the light that is transmitted by the filter may be absorbed and detected by that particular photosite. Sometimes micro-lenses 15 are disposed on top of each individual pixel to collect and focus more radiation, thus increasing the sensitivity of the sensor.

Typical image sensor technologies such as those based on charge couple devices (CCDs) and complimentary metal oxide silicon (CMOS) are less responsive to light in the short (i.e., blue and violet) wavelength regions of the visible spectrum because of the high absorption of these wavelengths by the lens material. Additionally, there may a limited penetration depth of this shorter wavelength light in those wavelengths in silicon. Unfortunately, much of the radiation is absorbed at the polysilicon gate region, with very little penetrating into the channel regions of the sensor where the photoelectric signal is generated.

There has been a variety of attempts made in the prior art to circumvent these problems. Some of these attempts have made use of structural modifications that include back-side illuminating thinned devices, pinned photodiodes, and indium tin oxide (ITO) gated CCD sensors. These approaches have achieved relatively good results in terms of short-wavelength spectral response, but at the high cost of complicated fabrication.

### SUMMARY OF THE INVENTION

Embodiments of the present invention are directed to apparatus and methods of improving of the spectral responsivity of color image sensors that are inherently inefficient in the short wavelength range of the visible spectrum. By using a phosphor composition as a spectral shifter to absorb the short wavelength portion of the incident light, the phosphor then r e-emitting the light at longer wavelengths, the maximum of spectral response (the peak of quantum efficiency) of sensor may be better matched. This greatly enhances the performance of the image sensor.

### BRIEF DESCRIPTION OF THE DRAWINGS

FIG. 1 is a schematic illustration of prior art techniques that used color filters to render gray-scaled brightness captured by an image sensor array into a color image; highlighted in the lower panel is the popular Bayer pattern of color filters;

FIG. 2 is a schematic illustration showing the replacement of blue filters with an appropriate phosphor to shift the photon flux of incident light from short wavelengths to long wavelengths, thus better matching the maximum spectral response of a color image sensor (the phosphor strongly absorbs the blue and violet part of incident light and re-emits near IR luminescence;

FIG. 3A is a schematic illustration showing how a phosphor coating layer may be deposited on a micro-lens, the phosphor needed to convert blue light into IR emission (not proportionally scaled); and

FIG. 3B is a schematic illustration showing how a phosphor coating layer may be deposited on the imaging lens to convert blue light into IR emission (again, not proportionally scaled).

### DETAILED DESCRIPTION OF THE INVENTION

Disclosed herein are the apparatus and methods for effectively improving the limitations imposed by the color filters of the prior art. Embodiments of the present invention utilize phosphors to convert short-wavelength radiation into light having longer wavelengths. The presently taught phosphors may be implemented either by depositing a coating of the phosphor on the micro-lens that focuses light onto the image sensor, the phosphor converting blue light into an infrared emission, or by replacing the blue filter pixels with an appropriate phosphor, or a combination of both.

Phosphors are chemical compositions wherein rare earth elements are used to dope a crystalline host material. The emission wavelength of the phosphor may be tuned by both the host material and the particular selection of the rare earth dopant. The emission wavelength of the phosphor is in part determined by electron-phonon interactions (e.g., lattice vibrations) associated with the local crystal field of the phosphor. Their high brightness in emission, excellent chemical stability, and high quantum efficiency make phosphors a much more robust and reliable choice relative to alternative luminescent materials such as organic dyes.

By choosing an appropriate phosphor that has strong absorption of nearly all the light of a wavelengths smaller than its absorption edge (e.g., higher energy), the phosphor acts as spectral shifter by re-emitting photons in a longer wavelength range (e.g., lower energy) that better match the spectral response of an image sensor. In particular, it is the maximum of the spectral response whose matching is desired. The lower energies, and/or longer wavelengths that are desired lie in the near infrared (IR) region of the electromagnetic spectrum for conventional CCD and CMOS image sensors.

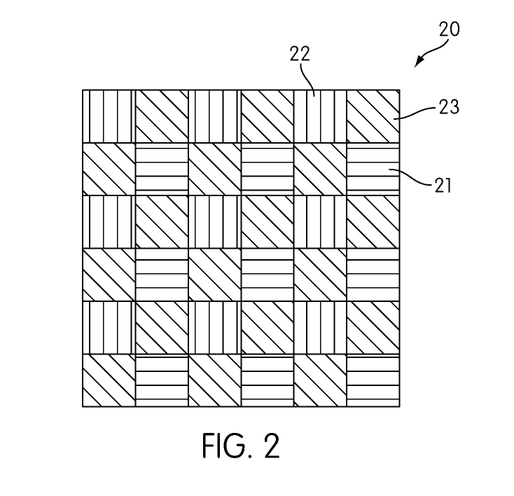

In one embodiment of the present invention, a blue filter of the prior art design may be directly replaced by a phosphor provided that the lens materials are transparent to those wavelengths, and that the sensor's responsivity is low (typically less than about 30 to 40 percent quantum efficiency) in the blue color range. This concept is illustrated at 20 in FIG. 2, showing the present phosphor 21, the prior art red filter 22, and the prior art green filter 23. The present phosphor 21 has the property that blue-violet portion of visible light may be absorbed, and that at least a portion of this energy may be re-radiated as luminescence in the near IR region. The re-radiated luminescence may have a relatively broad emission having a peak around 780 to 900 nm; this is the region where silicon-based CCD or CMOS image sensors normally have their maximum spectral response. Often, this response may be over about 90 percent quantum efficiency.

It may be desirable to have the conversion efficiency of the phosphor as close to 100 percent as possible. The isotropic nature of phosphor luminescence implies that the phosphor emits about 50 percent of its energy in a direction away from the sensor. Fortunately, a fraction of this portion of the emitted luminescence of the phosphor may be collectable, and redirected towards the sensor through total internal reflection at the phosphor layer and air interface. The amount of the luminescence to be recovered may be up to 20 to 25 percent, depending on the design of the optics. This embodiment can lead to an overall improvement of more than about 20 percent in the spectral responsivity of the color image sensor.

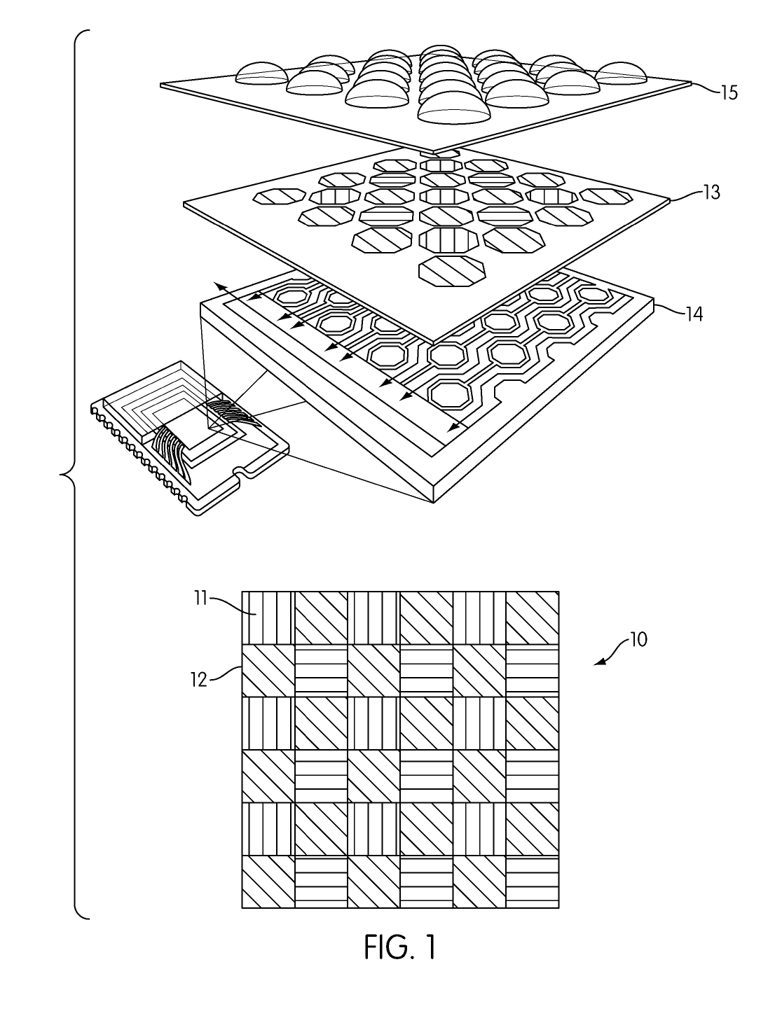

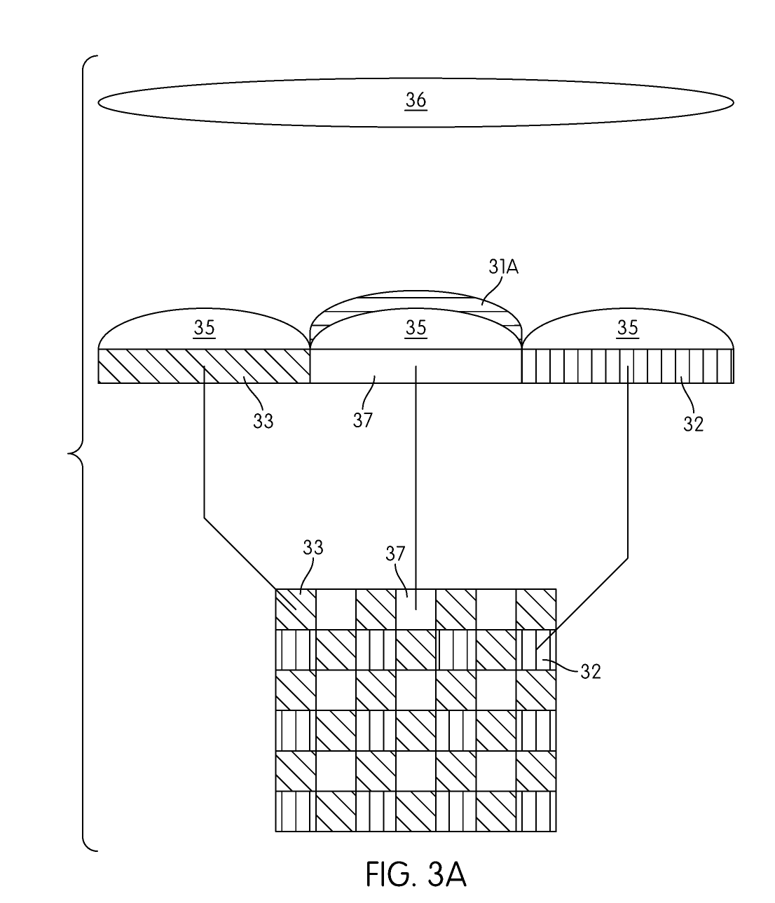

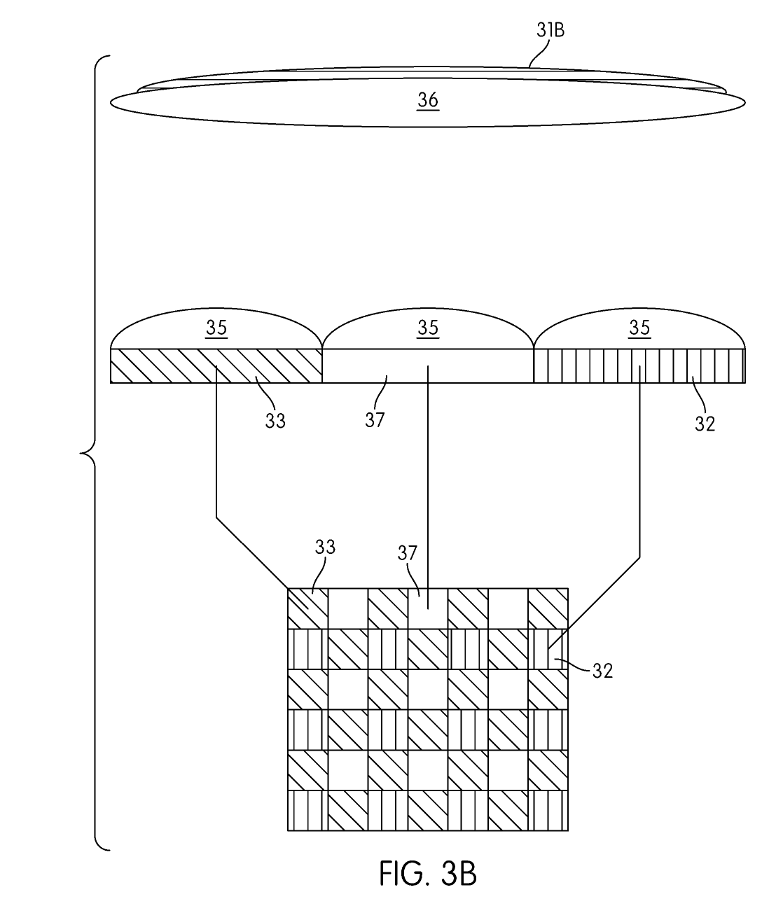

In another embodiment, a layer of the presently disclosed phosphor 31A may be deposited on top of the micro-lenses 35 and in front of the red filters 32 and green color filters 33 (see FIG. 3A). In yet another embodiment, the presently disclosed phosphor 31B may be deposited on the imaging lens 36 that collects and focuses light onto the color image sensor (see FIG. 3B), if the lens materials has a strong absorption in the short wavelengths of visible spectrum. In these embodiments, the blue filters in the popular Bayer pattern for color rendering shown previously in FIG. 1 may be completely eliminated from the structure, since the incident light in the blue region is converted into IR emission 37 by the phosphor coating 31A, 31B. FIGS. 3A-B also show the modified pattern for the remaining red and green color filters. To further improve the signal-to-noise ratio of the image sensor, the blue filters may be replaced by IR bandpass filters that are configured to transmit only the emitted light from the phosphor.

It is important to note that the encoded color signal(s) from an array of color image sensors does not convey any real wavelength information relative to the original hue. For example, if a predominantly orange color is imaged the red sensor will describe the light as some intensity of red only. However, the green sensor will also image some part of this orange light and convey some intensity of what is essentially green light. This only works because the optical color filters are bandpass filters in nature, and thus posses finite selectivity. If they were discrete monochromatic filters, the color imaging system would fail. This phenomenon highlights the ratiometric nature of the imaging system; i.e., the overlapping and gradual gradation of the color filters; all three filter have a weighted proportion of the visible spectrum. Therefore, it is desirable to select a phosphor with a relatively broad bandwidth of emission comparable to that of the blue filter(s) the phosphor is replacing.

What is claimed is:

1. A phosphor spectral shifter in a color image sensor, the phosphor configured to absorb short wavelengths of light in the visible spectrum, and re-emit light in longer wavelengths, the longer wavelengths substantially matched to the spectral response of the image sensor.

2. A color image sensor comprising:
an array of color filters comprising at least one red filter and at least one green filter, the at least one red positioned on top of a first photosite of the image sensor, and the at least one green filter positioned on top of a second photosite of the image sensor; and
a phosphor coating layer for converting blue light into a longer wavelength, infrared emission, the phosphor coating layer positioned on top of a third photosite of the image sensor.

3. The color image sensor of claim 2, further comprising an array of micro-lenses for focusing light onto the photosites of the image sensor, one micro-lens for each red filter, each green filter, and each blue phosphor coating.

4. The color image sensor of claim 2, further comprising an imaging lens for focusing light onto the array of micro-lenses.

5. The color image sensor of claim 3, wherein the phosphor coating layer is deposited onto a micro-lens of the micro-lens array.

6. The color image sensor of claim 4, wherein the phosphor coating layer is deposited onto the imaging lens.

7. The color image sensor of claim 2, wherein the phosphor coating comprises a composition selected from the group consisting of aluminate and silicate-based phosphors.

8. A method of sensing a color image, the method comprising:
filtering light with a green filter, and passing the green filtered light onto a first photosite of a color image sensor;
filtering light with a red filter, and passing the red filtered light onto a second photosite of a color image sensor; and
using a phosphor to spectrally shift shorter wavelength light in the blue to violet regions of the visible spectrum to longer wavelength light in the infrared region of the electromagnetic spectrum, and passing the longer wavelength light to a third photosite of the color image sensor.
